(19) United States
(12) Patent Application Publication
(10) Pub. No.: US 2011/0145736 A1
(43) Pub. Date: Jun. 16, 2011

(54) Systems and Methods for Designing a Universal User Interface

(75) Inventors: Christian Mahr, Zuzenhausen (DE); Thomas Frambach, Heidelberg (DE)

(73) Assignee: SAP AG

(21) Appl. No.: 12/637,230

(22) Filed: Dec. 14, 2009

(51) Int. Cl. G06F 3/01

(52) U.S. Cl. 715/762

(57) ABSTRACT

Methods and systems consistent with embodiments of the present invention for designing a user interface. As disclosed herein, the method is implemented by a computer system that has at least one memory for storing data and instructions and at least one processor. The at least one processor is configured to access the at least one memory, to execute at presentation logic comprising at least one software module and to perform the steps of determining, by the presentation logic, a plurality of simple user interface elements within the user interface to be designed based on the requirements. Each simple user interface element contains one data input field. The at least one processor also performs the steps of receiving rules and parameters governing design of the user interface, combining the plurality of simple user interface elements into one or more complex user interfaces based on the rules and parameters, and displaying a user interface comprising the one or more complex user elements. The one or more complex user interfaces contain the input fields from the plurality of simple user interface elements.

### BACKGROUND

1. Relevant Field

Systems and methods consistent with the presently-claimed invention generally relate to the design and implementation of a user interface. More particularly, systems and methods consistent with the presently-claimed invention provide a flexible framework for developing and modifying a user interface without a need for changing other parts of a computer system in which it is being used.

2. Background Information

Common application systems are designed using “tiers,” such as a presentation tier (user interface or UI), a logic tier, and a data tier. The main function of the presentation tier or UI is to facilitate interaction between humans and computer systems by inviting and responding to user input and translating tasks and results to a language or image that the user can understand. The logic tier is the layer that coordinates the application, processes commands, makes logical decisions and evaluations, performs calculations, and moves data between the presentation and data tiers. The data tier stores and retrieves information from databases or file systems. The information is then passed back to the logic tier for processing, and eventually back to the user via the UI.

In some application systems, some of the tiers may be combined. However, combining the tiers makes the application less flexible, difficult to modify or debug, and generally more difficult to maintain.

Moreover, user interface code tends to be more device-dependent than business logic. Applications may share the same business logic but the user interface code for a browser-based application on one personal digital assistant (PDA) may differ from that used by a Web-enabled cell phone, for example. If an application is designed with a clean separation of the presentation and business logic, the application can be swiftly adapted for new devices with minimal error by modifying only the user interface code.

The Model View Controller (MVC) design pattern provides one framework for decoupling data access, business logic, and data presentation/user interaction. In an MVC design pattern, an application is typically broken into three parts: a model (processing), a view (output), and a controller (input). The architectural pattern isolates business logic from the input and the presentation logic, allowing independent development and maintenance of each of the parts.

Although widely used, MVC-based frameworks have many disadvantages. For example, MVC-based frameworks, like all other multi-layer mechanisms, are hard to debug. Furthermore, MVC-based frameworks are fairly complex, requiring creating three separate classes (model, view, and controller) where only one would be needed in simple screen frameworks. Another drawback with MVC-based frameworks is the lack of any capability for the model to request specific input from a user depending on application processing outcomes. For example, if the input from the user varies depending on the outcome of certain internal processing operations or the information the model needs cannot be known in advance, then the controller cannot be programmed to know in advance the presentations to make and data to gather because the presentation to make and data to gather may vary at certain processing points.

Therefore, there is a need for a framework for designing user interfaces that is flexible and simple, that allows for easy modification of code and which is easy to debug.

### SUMMARY

Generally, one aspect of the presently-claimed invention is a method for designing a user interface. The method is implemented by a computer system including at least one memory for storing data and instructions, at least one processor configured to access the at least one memory and to execute at presentation logic comprising at least one software module. The at least one processor performs the steps of determining, by the presentation logic, a plurality of simple user interface elements within the user interface to be designed based on the requirements, wherein each simple user interface element contains one data input field, receiving rules and parameters governing design of the user interface, combining the plurality of simple user interface elements into one or more complex user interfaces based on the rules and parameters, wherein the one or more complex user interfaces contain the input fields from the plurality of simple user interface elements. The at least one processor also performs the step of displaying a user interface comprising the one or more complex user elements.

In some embodiments of the foregoing aspect of the presently-claimed invention, the rules and parameters are specified using a block diagram model. In other embodiments of the presently-claimed invention, the block diagram model contains a plurality of blocks, each block having associated settings that control operation of the block, and wherein the block diagram model provides a graphical model of the user interface to be designed.

According to some embodiments of the presently-claimed invention, the method further includes the step of combining at least one simple user interface element with the one or more complex user interface element until the user interface to be designed is implemented. In some embodiments of the presently-claimed invention, the step of combining further comprises replacing the plurality of simple user interface elements with the one or more complex user interface elements. validating data in each of the plurality of simple user elements by comparing the data to prior data stored in a database. Each of the plurality of simple user elements contains a title, an input field, a message field, and an entry button for navigation.

In another embodiment of the presently-claimed invention, the method further includes the step of validating further comprises outputting a validation message if the data in each of the plurality of simple user elements is correct. In some embodiments of the presently-claimed invention, the step of validating further comprises outputting an error message if the data in each of the plurality of simple user elements is incorrect.

Generally, one aspect of the presently-claimed invention is a computer system for designing a user interface. The system includes a memory device storing data and instructions, and a processor configured to access the memory and to execute at least one software module comprising a presentation logic, to perform the computer-implemented steps of determining, by the presentation logic, a plurality of simple user interface elements within the user interface to be designed based on the requirements, receiving rules and parameters governing design of the user interface, and combining the plurality of simple user interface elements into one or more complex user interfaces based on the rules and parameters. Each simple user interface element contains one data input field, and the one or more complex user interfaces contain the input fields from the plurality of simple user interface elements. The processor also performs the step of displaying a user interface comprising the one or more complex user elements.

Another aspect of the presently-claimed invention is a computer-readable storage medium including instructions which, when executed on a processor, cause a processor to perform a method of designing a user interface, the processor executing at least one software module comprising a presentation logic, the method including the computer-implemented step, performed by a computer, of determining, by the presentation logic, a plurality of simple user interface elements within the user interface to be designed based on the requirements, wherein each simple user interface element contains one data input field. The method also includes the steps of receiving rules and parameters governing design of the user interface, combining the plurality of simple user interface elements into one or more complex user interfaces based on the rules and parameters, and displaying a user interface comprising the one or more complex user elements. The one or more complex user interfaces contain the input fields from the plurality of simple user interface elements

It is to be understood that both the foregoing general description and the following detailed description are exemplary and explanatory only, and should not be considered restrictive of the scope of the inventions, as described and claimed. Further, features and/or variations may be provided in addition to those set forth herein. For example, embodiments of the inventions may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the presently-claimed invention. In the drawings:

FIG. 1 is a flowchart illustrating an exemplary method for designing a user interface, consistent with embodiments of the presently-claimed invention;

FIG. 2 is an exemplary user interface to be designed;

FIG. 3a is a flowchart illustrating an exemplary method for entering an address of a user, consistent with embodiments of the presently-claimed invention;

FIG. 3b illustrates the exemplary user interface shown in FIG. 2 as five sets of simple user interface elements consistent with the presently-claimed invention;

FIG. 4 illustrates how four of the sets of simple user interface elements shown in FIG. 3b may be combined to form a complex user element, consistent with embodiments of the presently-claimed invention;

FIG. 5 shows an exemplary system for implementing embodiments of the presently-claimed invention; and

FIG. 6 also shows an exemplary system for implementing embodiments of the presently-claimed invention.

### DETAILED DESCRIPTION

The following detailed description refers to the accompanying drawings. Wherever possible, the same reference numbers are used in the drawings and in the following description to refer to the same or similar parts. While several exemplary embodiments and features of the presently-claimed invention are described herein, modifications, adaptations and other implementations are possible, without departing from the spirit and scope of the inventions. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the inventions are defined by the appended claims.

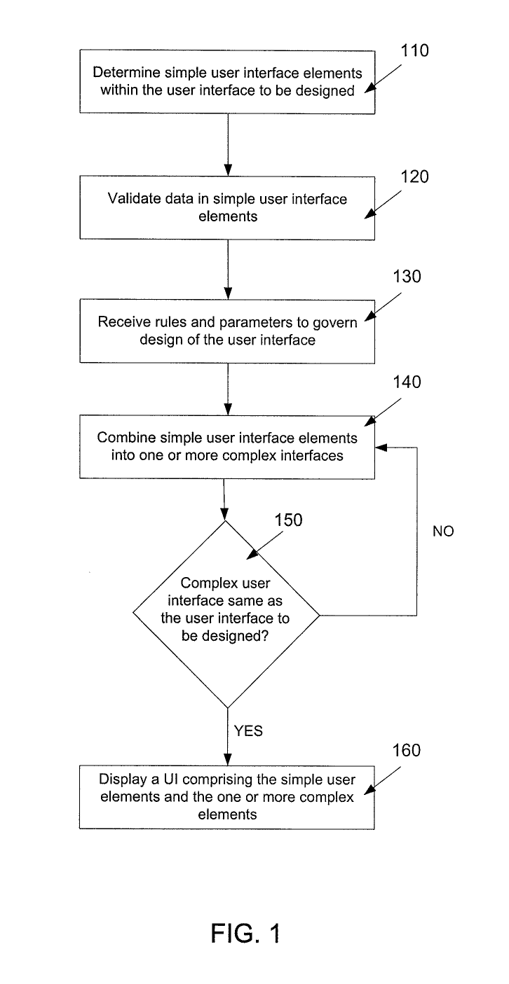

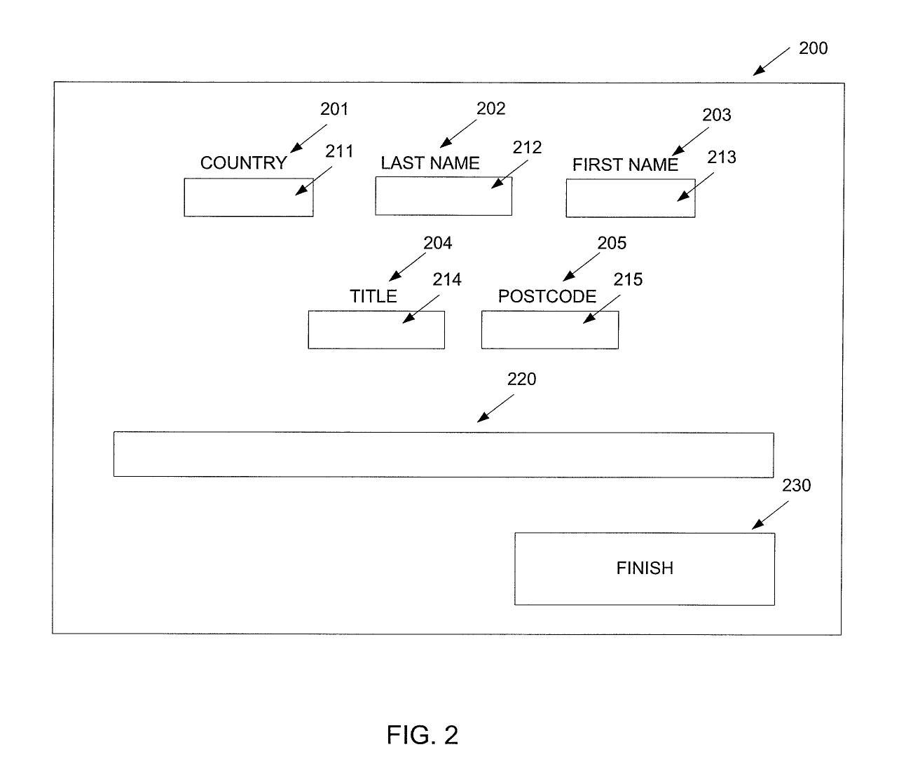

FIG. 1 is a flowchart illustrating an exemplary method for designing a user interface, consistent with embodiments of the presently-claimed invention. The method may be used to create a new user interface for a particular business application for a new device or an existing client. An exemplary user interface to be designed consistent with embodiments of the presently-claimed invention is illustrated in FIG. 2. In this simple exemplary case, UI 200 is a full screen user interface comprising five titles (201, 202, 203, 204, 205) and data input fields (211, 212, 213, 214, 215). As shown in FIG. 2, UI 200 also comprises a message area 220 and a navigation button 230. One of ordinary skill would appreciate that the titles and data input fields are not limited to what is shown in FIG. 2. In other examples or implementations of the presently-claimed invention, user interface 200 may have more or different titles and data input fields.

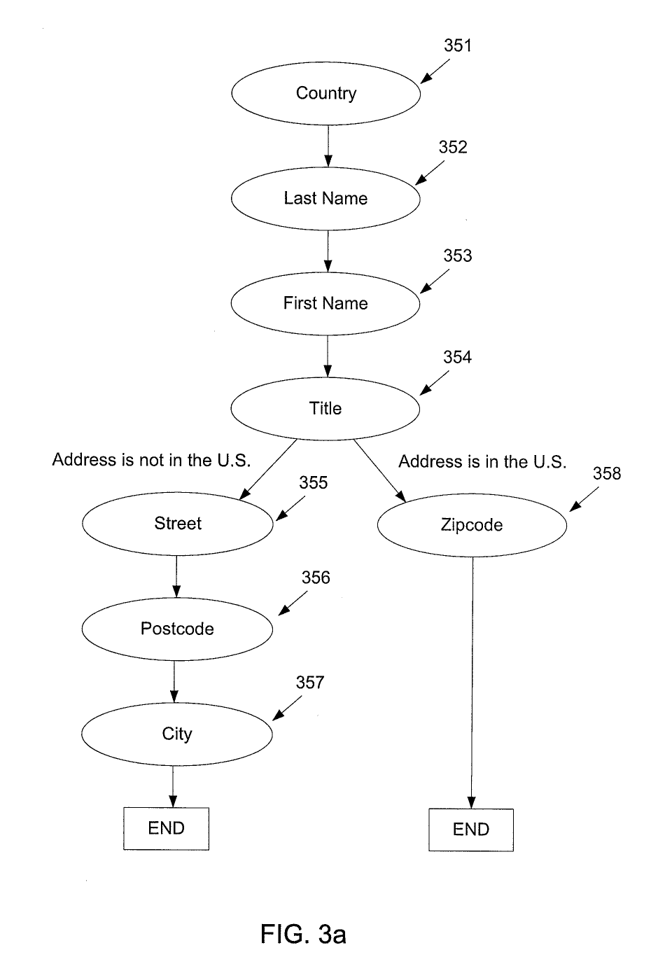

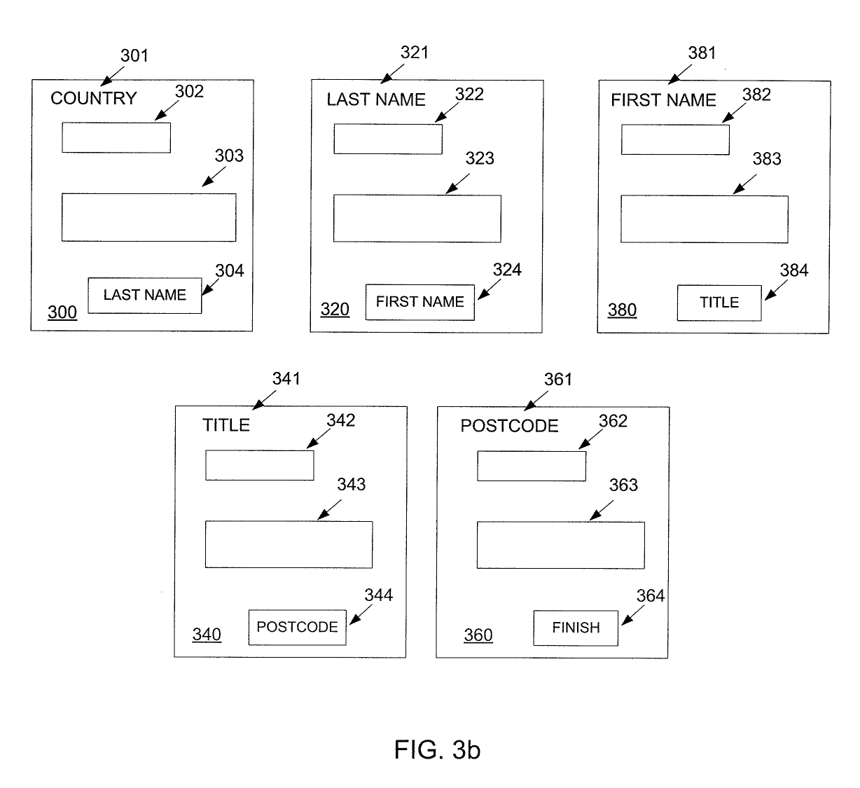

To start, simple UI elements within the user interface are determined in step 110. To determine the simple UI elements, the fields shown in FIG. 2 first need to be determined. The fields that will be used in the user interface to be designed may be determined, for example, by recording a user's key strokes into coding language. The fields and the input of the fields can also be retrieved by simple observation. FIG. 3a illustrates an exemplary method for entering an address of a user. As shown in FIG. 3a, users may be prompted to enter country 351, last name 352, first name 353, and title 354. If the user enters “United States” in country 351, the user may be prompted to only enter zipcode 358. Alternatively, users outside the United States may be prompted to enter street 355, postal code 356, and city 357. One of ordinary skill would appreciate that these fields were chosen for exemplary purposes only and that other fields are possible. In certain embodiments, some or all fields may be populated automatically by, for example, using a macro recorder automatically.

The data fields that are presented, the type of data that is collected, and the order in which it is collected, may differ according to certain rules. For example, as discussed above, if “United States” is entered into country 351, the system may only collect zipcode 358, and from the zipcode determine the city. However, if some other country is entered into country 351, the system may collect different information.

Returning to FIG. 1, the system may optionally choose to validate the data captured in one or more fields (as shown in step 120 of FIG. 1). To validate the data, the system may, for example, compare the data with prior data stored in a database. The system may also, for example, check the data to see if it conforms with an expected format or data type. For example, if a United States zip code is entered, for example, the system may check to see that it is five or nine digits long (the expected format), whereas if a postal code is entered, the system may allow letters to be entered. Based on the comparison, the system may output either a validation (if the data is correctly entered) or an error message (if the data is not correct).

FIG. 3b illustrates the exemplary user interface shown in FIG. 2 as five sets of simple user interface elements consistent with the presently-claimed invention. As shown in this example, each simple user interface element contains one data input field. For example, simple UI element 300 comprises title 301 (“country”), a single input field 302, a message area 303, and a button 304 for the user to navigate to the next screen. Title 301 specifies the data type for simple UI element 300. Input field 302 allows the user to enter data corresponding to the data type specified by title 301, such as, for example, the name of the country in the exemplary simple UI element 300.

Additional information may be displayed in message area 303. For example, when the user enters data corresponding to the name of the country, and the system fails to validate this data, a message such as “the country you have entered does not exist” may be displayed in message area 303. Further, by clicking on button 304, the user may navigate away from the current screen to another screen, such as screen 320, which may be used for entering additional data, such as data related to the last name of the user. Simple UI elements 320, 340, 360, and 380 display similar information. The user may end the process by, for example, clicking on the “Finish” button 364 in UI 360. Other examples or implementations of the presently-claimed invention may display elements in different arrangements. Moreover, other examples may have different input structures with different input parameters. For example, one exemplary embodiment may have a simple UI element for displaying zipcode information.

Based on the information obtained from the user input or populated by a machine using a macro recorder into the simple UI elements, the field groups of simple UI elements are determined, and complex user interface elements are chosen. Standard tools may be used to perform these steps. For example, when using SAP Windows GUI, a script engine outputs Visual Basis Coding. Next, a set of rules and parameters may be defined for creation of the user interface. Such rules or parameters may be defined by, for example, the UI developer or UI designer, or defined dynamically or actively by the system.

In one embodiment, the simple UI elements, complex elements, and/or rules and parameters may be specified using a standard UI design workbench, such as SAP's Web Dynpro ABAP workbench. The construction of the UI elements may be illustrated using block diagram models by which the desired flow of user interaction with the user interface to be designed can be represented as a series of function blocks, each representing a function. The block diagram models typically include lines for representing interconnections between the function blocks and representing data flow through the block diagram model. The functions of each block and interconnections are translated into rules and constraints for designing the user interface.

In step 130, these rules and constraints are received for governing the design of the user interface. Such rules and constraints may be called the replacement rules. The rules specify relationships between the simple UI elements and specify which simple UI elements may be combined to for complex UI elements.

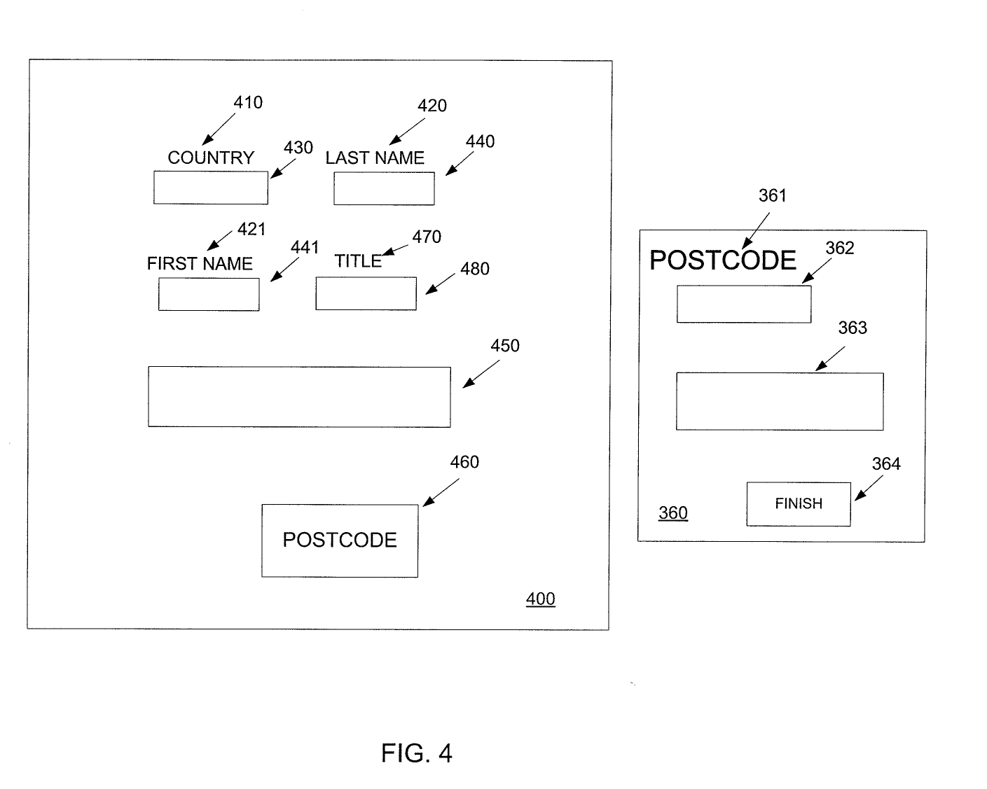

In step 140, if any of the replacement rules are satisfied, two or more simple UI elements (such as simple UI elements 300, 320, 340, 380) may be combined to create one or more complex UI elements. The one or more complex UI elements replace the two or more simple UI elements. FIG. 4 illustrates how four of the sets of simple user interface elements shown in FIG. 3b may be combined to form a complex user element, consistent with embodiments of the presently-claimed invention. UI 360 represents the simple UI element of “postcode” as illustrated in FIG. 3b. UI 400 represents the combination of simple UI elements 300, 320, 340 and 380, including all the input fields from the simple UI elements, as shown in FIG. 3b. For example, UI 400 comprises titles 410, 420, 421, and 470, representing corresponding titles 301, 321, 341, and 381 from FIG. 3b, and data input fields 430, 440, 441 and 480, representing corresponding data input fields 302, 322, 342 and 382 from FIG. 3b. The combination transforms the four screens, each of them containing a single input field, into a single screen containing four input fields. Moreover, UI 400 comprises a message field 450, representing 303, 323, 343, and 383. This may be based on one of the rules received in step 130.

Moreover, based on the information provided in country data input field 351 (shown in FIG. 3a), a simple UI element different than simple UI element 360 may be combined with UI 400. For example, if “United States” is entered into country 351, the system may only collect zipcode 358, and therefore combine complex UI 400 with a simple UI element for zipcode. However, if some other country is entered into country 351, the system may collect different information combining different simple UI elements.

The system checks in step 150 whether the complex UI element matches the UI to be designed, for example, UI 200 in FIG. 2. If the complex UI element does not match, then step 140 is repeated until the UI to be designed is completed. For example, as shown in FIG. 4, the set of elements does not match UI 200 of FIG. 2. Therefore, the system continues to combine elements, in this example combining single UI element 360, representing the postcode, with complex UI element 400. When the resulting complex UI element matches the UI to be designed, the system displays the resulting UI (step 160).

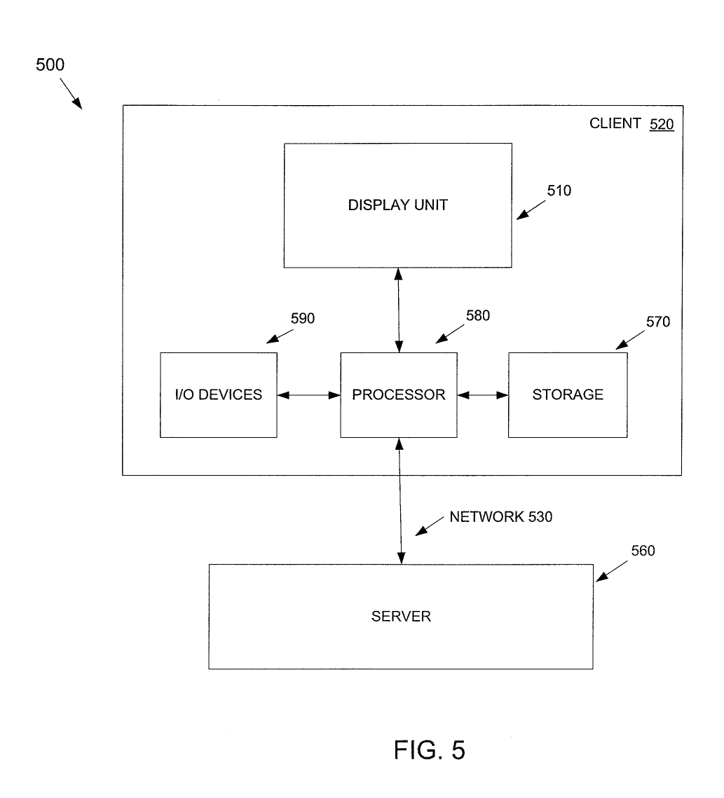

FIG. 5 is an exemplary system for designing a user interface, consistent with embodiments of the presently-claimed invention. Exemplary system 500 comprises a general purpose computing system, wherein general purpose computers, workstations, or personal computers (not shown in the Figure) are connected via communication links of various types, wherein programs and data, many in the form of objects, are made available and shared by various members of the system for execution and access by other members of the system.

As shown in FIG. 5, system 500 comprises a client 520 and a server 560. Client 520 and server 560 can communicate with one another over network 530. Client 520 comprises a display unit 510, I/O devices 590, a processor 580, and a storage 570. Processor 580 is operatively connected to display unit 510 via a wire or wireless connection. Processor 580 may be configured for routing information among components and devices and for executing instructions from one or more memories. Although FIG. 5 illustrates a single processor, system 500 may include a plurality of general-purpose processors and/or special purpose processors (e.g., ASICS).

Processor 580 may by operatively connected (via wired or wireless connection) to one or more I/O devices 590. I/O devices 590 may include components such as keyboard, a mouse, a pointing device, and/or a touch screen. I/O devices 590 may also include audio- or video-capture devices. In addition, I/O devices 590 may include one or more data reading devices and/or input ports. In certain embodiments, I/O devices 590 may be operatively connected (wired or wireless) to display unit 510. System 500 may present information and interfaces (e.g., GUIs) via display unit 510. Display unit 510 may be configured to display text, images, or any other type of information. In certain configurations, display unit 510 may present information by way of a cathode ray tube, liquid crystal, light-emitting diode, gas plasma, or other type of display mechanism. Display unit 510 may additionally or alternatively be configured to audibly present information. Display unit 510 may be used in conjunction with I/O devices 590 for facilitating user interaction with system 500.

Storage 570 may be used to store instructions, such as an application program, which may be executed by processor 580 to cause computer system to implement a plurality of operations. Storage 570 may provide mass storage and/or cache memory for system 500. Storage 570 may be implemented using a variety of suitable components or subsystems. Storage 570 may include a random access memory, a read-only memory, magnetic and optical storage elements, organic storage elements, audio disks, and video disks. In certain configurations, storage 570 may include or leverage one or more programmable, erasable and/or re-useable storage components, such as EPROM (erasable programmable read-only memory) and EEPROM (electrically erasable programmable read-only memory). Storage 570 may also include or leverage constantly-powered nonvolatile memory operable to be erased and programmed in blocks, such as flash memory (i.e., flash RAM). Although system 500 is illustrated with only one storage 570, system 500 may in fact have multiple storage components, and each may be configured for performing distinct functions.

Storage 570 may include program code for various applications, an operating system, an application-programming interface, application routines, and/or other executable instructions. Storage 570 may also include program code and information for communications (e.g., TCP/IP communications), kernel and device drivers, and configuration information. In embodiments consistent with the presently-claimed invention, one or more software modules for implementing the steps of the method by be stored on storage 570 and/or other components, and may be run using processor 580 or the like.

In at least one embodiment, I/O devices 590 may include components such as input field buttons. When a button or key is pressed on I/O devices 590, processor 580 displays the key stroke and display unit 510 displays the result. Moreover, the system may also store the result in memory. When the finish button is pressed, processor 580 retrieves the associated data and command from storage 570 and sends them to server 560.

Similar workstations may be connected by one or more communications paths to form a distributed computer system. The workstations may be operatively configured to form a network, such as a wide-area network (WAN), a local-area network (LAN), or the Internet.

Moreover, display unit 510 may be used to display graphical user interfaces, which may be used to output or receive input of data.

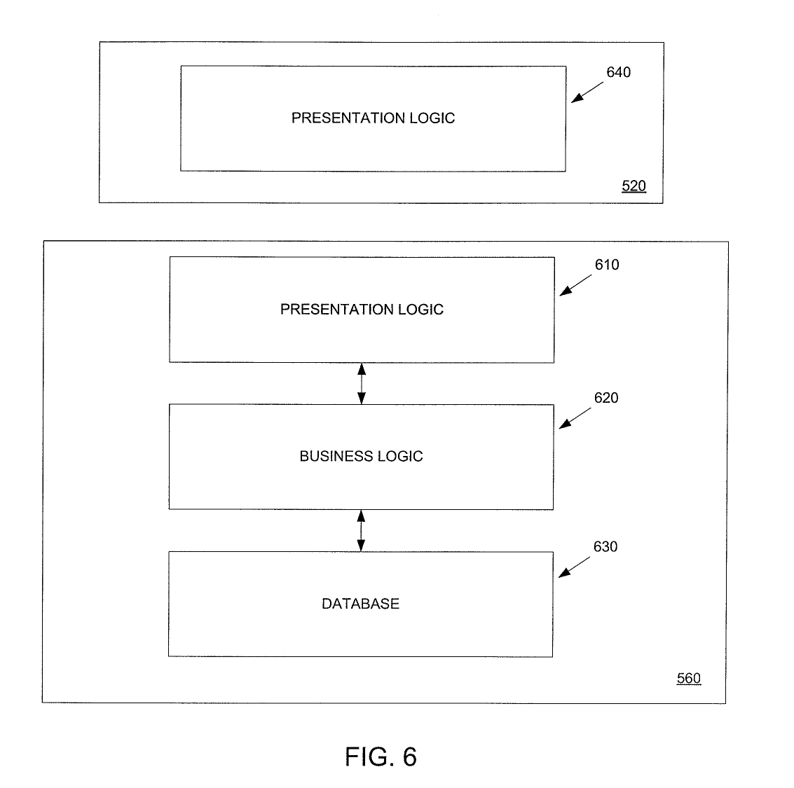

FIG. 6 is an exemplary server architecture of a system for designing a user interface consistent with embodiments of the presently-claimed invention. As shown in FIG. 6, an exemplary system comprises a client 520 and a server 560. Client 520 is depicted as comprising presentation logic 640, which comprises software modules which, when executed by a processor, perform the steps of the methods as presently claimed. FIG. 6 illustrates that presentation logic may be present in one or both of client 520 and server 560, as illustrated by presentation logics 640 and 610. Presentation logic 640 comprises instructions that interpret input from a user interface. Presentation logic 640 may be hardware, software, or a combination of hardware and software. Server 560 includes a presentation logic 610, a business logic 620, and a database 630.

The data that is entered and the actions that are triggered by user are received by the user interface and become input to the presentation logic 610. They are translated into commands and data usable by the business logic to carry out the functions of the application. Business logic 620 moves and processes data between two surrounding layers, and comprises the functional algorithms that handle information exchange between database 630 and presentation logic 610. Business logic 620 coordinates applications, processes commands, makes logical decisions and evaluations. Moreover, business logic 620 may prescribe how objects interact with one another, and may enforce rules or methods by which objects are accessed and updated. Database 630 includes the rules for governing the design of the user interface and its objects.

The foregoing description has been presented for purposes of illustration. Other embodiments of the presently-claimed invention will be apparent to those skilled in the art from consideration of the specification and practice of the inventions disclosed herein. It is intended that the specification and examples be considered as exemplary only, with a true scope and spirit of the inventions being indicated by the following claims.

What is claimed is:

1. A computer-implemented method of designing a user interface, the method being implemented by a computer system comprising at least one memory for storing data and instructions, at least one processor configured to access the at least one memory and to execute at presentation logic comprising at least one software module, to perform the steps of:
determining, by the presentation logic, a plurality of simple user interface elements within the user interface to be designed based on the requirements, wherein each simple user interface element contains one data input field;
receiving rules and parameters governing design of the user interface;
combining the plurality of simple user interface elements into one or more complex user interfaces based on the rules and parameters, wherein the one or more complex user interfaces contain the input fields from the plurality of simple user interface elements; and
displaying a user interface comprising the one or more complex user elements.

2. The method of claim 1, wherein the rules and parameters are specified using a block diagram model.

3. The method of claim 2, wherein the block diagram model contains a plurality of blocks, each block having associated settings that control operation of the block, and wherein the block diagram model provides a graphical model of the user interface to be designed.

4. The method of claim 1, further comprising combining at least one simple user interface element with the one or more complex user interface element until the user interface to be designed is implemented.

5. The method of claim 1, wherein combining further comprises replacing the plurality of simple user interface elements with the one or more complex user interface elements.

6. The method of claim 1, wherein each of the plurality of simple user elements contains a title, an input field, a message field, and an entry button for navigation.

7. The method of claim 1, further comprising validating data in each of the plurality of simple user elements by comparing the data to prior data stored in a database.

8. The method of claim 7, wherein validating further comprises outputting a validation message if the data in each of the plurality of simple user elements is correct.

9. The method of claim 7, wherein validating further comprises outputting an error message if the data in each of the plurality of simple user elements is incorrect.

10. A computer system for designing a user interface comprising:
a memory device storing data and instructions; and
a processor configured to access the memory and to execute at least one software module comprising a presentation logic to perform the computer-implemented steps of:
determining, by the presentation logic, a plurality of simple user interface elements within the user interface to be designed based on the requirements, wherein each simple user interface element contains one data input field;
receiving rules and parameters governing design of the user interface;
combining the plurality of simple user interface elements into one or more complex user interfaces based on the rules and parameters, wherein the one or more complex user interfaces contain the input fields from the plurality of simple user interface elements; and
displaying a user interface comprising the one or more complex user elements.

11. A computer-readable storage medium including instructions which, when executed on a processor, cause a processor to perform a method of designing a user interface, the processor executing at least one software module comprising a presentation logic, the method including the computer-implemented steps, performed by a computer, of:
determining, by the presentation logic, a plurality of simple user interface elements within the user interface to be designed based on the requirements, wherein each simple user interface element contains one data input field;
receiving rules and parameters governing design of the user interface;
combining the plurality of simple user interface elements into one or more complex user interfaces based on the rules and parameters, wherein the one or more complex user interfaces contain the input fields from the plurality of simple user interface elements; and
displaying a user interface comprising the one or more complex user elements.
